(19) United States
(12) Patent Application Publication
(10) Pub. No.: US 2005/0225796 A1
(43) Pub. Date: Oct. 13, 2005

(54) Wide area network printing system, document server, and image forming apparatus

(75) Inventor: Katsushi Horihata, Kobe-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 10/823,334

(22) Filed: Apr. 12, 2004

(51) Int. Cl. G06F 3/12; G06F 15/173

(52) U.S. Cl. 358/1.15

(57) ABSTRACT

A wide area network printing system receives print data from a contents server. A document server then sends the print data to a printer that is remote from the document server but in communication therewith via the Internet for printout. The document server determines a payer based on the document ID sent from the printer, and stores accounting data. The printer collects a fee from the print data recipient, if the print data recipient is judged to be the payer, but does not collect the fee from the print data recipient, if a print data provider is judged to be the payer. With this arrangement, the print fee is collected from the user depending on a judgment as to whether the print data is provided on fee-based service or for free. Thus, expenses relating to printout are collected properly.

### BACKGROUND OF THE INVENTION

1. Field of the Invention

The present invention relates to a technology for transmitting information stored in a server via the Internet to image forming apparatuses which are installed remotely away from but are communicatively connected with the server via the Internet to print the information.

2. Description of the Related Art

Heretofore, there has been known a network printing system in which a user can retrieve information stored in a server via the Internet with use of an image forming apparatus which is installed remotely away from the server but is communicatively connected therewith via the Internet to print a desired document by a printer incorporated in the image forming apparatus. Such a system is disclosed in Japanese Unexamined Patent Publication No. 2002-32205, for example. The network printing system is constructed in such a manner that a user (print data recipient) is allowed to send a document identification (ID) for identifying a document to be printed from a printer installed in a convenience store or the like to a print service server via the Internet. Upon receiving the document ID, the print service server retrieves print data identified by the document ID, and transfers the print data to the printer. Also, the print service server charges each user identifiable based on the document ID for a print fee and/or other expenses depending on the volume of print data.

The above network printing system is so configured that the users are charged of fees relating to all the print services in the case where print data is retrieved and printed out by the image forming apparatus installed in a convenience store or the like. In the above arrangement, even if a distributor, i.e., a print data provider wishes to provide the users with information for printing for free for the sake of advertisement and general publicity, the users are charged of the print fees, and the print fees are collected from the users, thereby making it impossible to provide the users with print service for free. On the other hand, if the system is so configured as not to impose a charge for any of print service to the users, there rises a problem that a shop owner of the convenience store or the like can not collect the cost required for printout of the print data.

### SUMMARY OF THE INVENTION

In view of the above, it is an object of the present invention to overcome the problems residing in the prior art. Specifically it is an object of the present invention to provide a system which is capable of automatically judging whether the print fee is to be collected from the user, depending on a judgment as to whether the print data is provided on fee-based service or for free, and securely collecting the cost relating to printout.

According to an aspect of the present invention, in a wide area network printing system which is so configured that, in response to receiving print data from a contents server providing various information including the print data, a document server sends the print data to an image forming apparatus which is installed remotely away from the document server but is communicatively connected therewith via the Internet for printout, wherein: the image forming apparatus comprises: an accepting unit that accepts input of a document ID used in verifying that receiving of print data is permitted; a sending unit that sends the document ID inputted intro the accepting unit to the document server; a receiving unit that receives print data from the document server; and an outputting unit that outputs the print data, and the document server comprises: a storing unit that stores the print data sent from the contents server, and the document ID in association with the print data therein; a print data retrieving unit that retrieves, from the storing unit, the print data identified by the document ID sent from the sending unit; an accounting unit that calculates a fee relating to printout of the print data retrieved by the print data retrieving unit, and stores the fee as accounting data; a payer judging unit that judges a payer of the fee relating to printout of the print data, based on the document ID; a data sending unit that sends the print data and the accounting data to the receiving unit of the image forming apparatus; and a controlling unit that controls the data sending unit to send, to the receiving unit of the image forming apparatus, the print data and the accounting data indicating that a print data recipient is the payer, if the payer judging unit judges that the print data recipient is the payer, and that controls the data sending unit to send, to the receiving unit of the image forming apparatus, the print data and the accounting data indicating that a print data provider is the payer, if the payer judging unit judges that the print data provider is the payer, the image forming apparatus further comprising fee collecting unit that collects the fee from the print data recipient in the case where the receiving unit of the image forming apparatus receives, from the data sending unit of the document server, the accounting data indicating that the print data recipient is the payer.

In the above arrangement, the accounting data indicating the fee relating to printout of the print data is stored in the accounting unit, and the payer is determined based on the document ID. If the payer judging unit judges that the print data recipient is the payer, the fee collecting unit collects the fee from the print data recipient. On the other hand, if the payer judging unit judges that the print data provider is the payer, the fee collecting unit do not collect the fee from the print data recipient. In this way, since the system is so configured as to automatically judge whether the user is charged for the print fee, the system makes it possible not to charge the user for the fee relating to printout of the print data if the print data provider such as a product distributor wishes to provide the users with information for printing (print data) for free for the sake of advertisement and general publicity. On the other hand, the system makes it possible for a shop owner to securely collect the cost required for printout of the print data from the print data provider, based on the accounting data stored in the accounting unit of the document server if the image forming apparatus is installed in the shop such as a convenience store.

These and other objects, features and advantages of the present invention will become more apparent upon reading of the following detailed description along with the accompanying drawings.

### BRIEF DESCRIPTION OF THE DRAWINGS

FIG. 1 is an illustration showing an entire configuration of a wide area network printing system according to an embodiment of the present invention.

FIG. 2 is a block diagram schematically showing an internal arrangement of a document server.

FIG. 3 is a block diagram schematically showing an internal arrangement of a printer.

FIG. 4 is a flowchart showing a printing process by the printer used in the wide area network printing system according to the embodiment.

FIG. 5 is a flowchart showing an exemplified process of judging a payer.

FIG. 6 is a flowchart showing processes by the printer and the document server in a process of judging whether print data is to be sent from the document server to the printer.

FIG. 7 is a flowchart showing processes by a contents server and the document server in a process of administering a document ID by the document server.

### DETAILED DESCRIPTION OF THE PREFERRED EMBODIMENTS

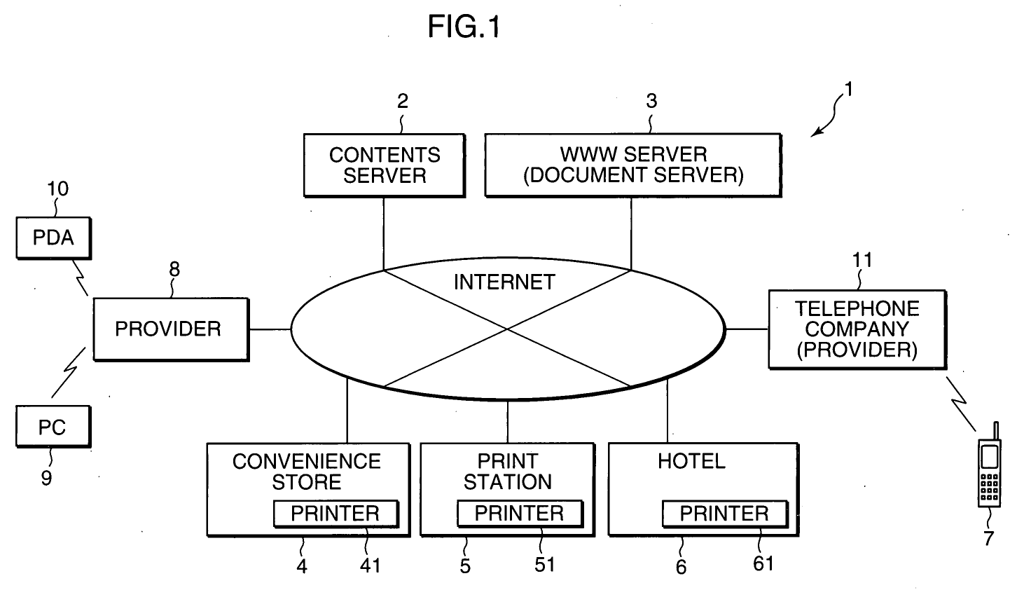

In the following, a wide area network printing system according to an embodiment of the present invention is described referring to the drawings. FIG. 1 is an illustration showing an entire configuration of the inventive wide area network printing system. The system 1 is constructed in such a manner that a contents server 2 storing print data sends the print data, via the Internet, to a document server 3 which is communicatively connected with the contents server 2 via the Internet for temporary storage, and the document server 3 sends the print data to a printer 41 (or 51 or 61) in a convenience store 4 (or a print station 5 or a hotel 6) for printing. The printers 41, 51, 61 are installed remotely away from the document server 3 but are communicatively connected therewith via the Internet.

The contents server 2 is a server having a database storing various information therein. For instance, the contents server 2 distributes print data which distributors or like agents dealing with products or goods use as a tool for the purpose of advertisement and general publicity. The contents server 2 allocates a contents identification (ID) to each print data to be provided to users, and also allocates, to each user (print data recipient) who are registered and allowed to receive the print data, a user ID for identifying each user. The contents server 2 creates a document ID used in verifying that the user is authorized to print out the print data, based on the contents ID and the user ID.

The contents server 2 sends a message that print data is suppliable, as well as the document ID, by way of an electronic mail or the like, to the users through various communications terminals such as portable telephones 7, personal computers (PCs) 9, and personal digital assistants (PDAS) 10. Plural document IDs may be created with respect to single print data.

The contents server 2 sends print data to be provided to the user along with the document ID to the document server 3, which in turn sends the print data to the printer 41, 51 or 61 installed in the convenience store 4, the print station 5 or the hotel 6.

The document server 3 stores the print data, and the document ID attached to the print data, and sends the print data to the printer 41 (51 or 61) via the Internet. The document server 3 sends, to the printer 41 (51 or 61), the print data identified by the document ID after authentication of the user based on the document ID in response to receiving the document ID from the printer 41 (51 or 61).

The printers 41, 51, 61 respectively installed in the convenience store 4, the print station 5, and the hotel 6 are communicatively connected with the document server 3 via the Internet for data communication. The printer 41 (51, 61) may have a printing function solely, or may be a so-called complex machine equipped with multi functions such as a printer, a copier, and a facsimile machine.

The reference numeral 8 denotes a provider which provides the users with services regarding connection with the Internet. The provider 8 allows the users to communicate data with the document server 3 via the Internet by way of the communications terminals such as the PCs 9 or the PDAs 10.

The reference numeral 11 denotes a telephone company. The telephone company 11 provides phone call services through the portable telephones 7, and provides services that enable the users to be accessible to the Internet from the portable telephones 7 for data communication. It is possible for the users to be accessible to the Internet by services of providers other than the telephone company 11. The portable telephone 7 has a data communication function, in addition to the ordinary phone call function.

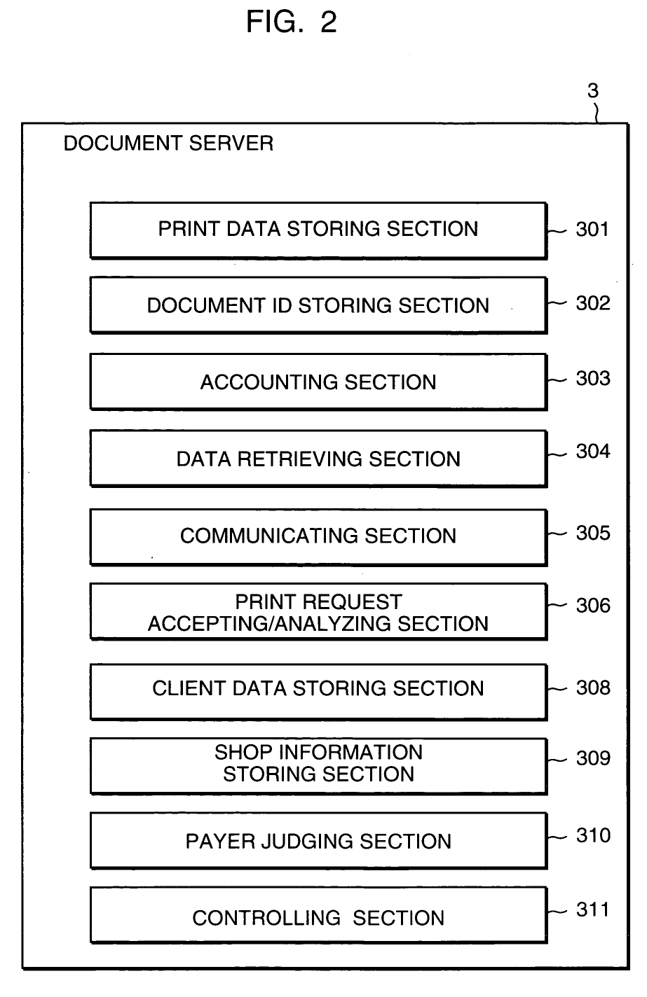

Next, an internal arrangement of the document server 3 is described. FIG. 2 is a block diagram schematically showing the internal arrangement of the document server 3. The document server 3 includes a print data storing section 301, a document ID storing section 302, an accounting section 303, a data retrieving section 304, a communicating section 305, a print request accepting/analyzing section 306, a client data storing section 308, a shop information storing section 309, a payer judging section 310, and a controlling section 311.

The print data storing section 301 stores the print data received from the contents server 2 in association with a document ID attached to the print data. The print data to be provided to each user is read out from the print data storing section 301, and is sent to the printer 41 (51 or 61) from which printout of the print data has been requested.

The document ID storing section 302 stores the document ID in association with the print data.

The accounting section 303 computes a print fee relating to printout of the print data, and stores the print fee as print-fee-related accounting data. The accounting section 303 also stores information relating to a payer who is determined by the payer judging section 301, as well as the accounting data.

The data retrieving section 304 retrieves, from the print data storing section 301, the print data identified by the document ID sent from the printer 41 (51 or 61). Further, the data retrieving section 304 reads out data (client data) relating to a client (user) from the client data storing section 308, and information (shop information) relating to the shop from the shop information storing section 309, and also reads out the print data in association with the client data and the shop information from the print data storing section 301. The client data and the shop information are retrieved in association with the document ID.

The communicating section 305 implements various data communications with the printer 41 (51 or 61) via a network interface (not shown) and the Internet. The communicating section 305 receives a command requesting transmission of the print data based on the document ID, and sends the print data to the printer 41 (51 or 61).

The print request accepting/analyzing section 306 analyzes the contents of the command requesting transmission of the print data based on the document ID, and sends an analysis result to the data retrieving section 304, and a relevant section, if necessary.

The client data storing section 308 stores the client data such as the number of the user's visits to the shop where the printer is installed, the accumulated used amounts by the user, and the print service valid period for the user.

The shop information storing section 309 stores information relating to the shop including the convenience store 4, the print station 5, and the hotel 6 where the printer 41, 51, and 61 are respectively installed, such as the kind of business, the location, the business scale, an approximate number of clients or users using the shop, the sales record, and the business hours.

The payer judging section 310 judges whether the payer is the print data provider such as the product distributor who administers the contents server 2, or the print data recipient, namely, the user, when the print data identified by the document ID is printed out with use of the printer 41 (51 or 61), based on the document ID sent from the printer 41 (51 or 61).

The controlling section 311 controls the data retrieving section 304 to retrieve the print data from the print data storage section 301 in response to the command requesting printout of the print data, based on the document ID sent from the printer 41 (51 or 61), and controls the communicating section 305 to send the print data.

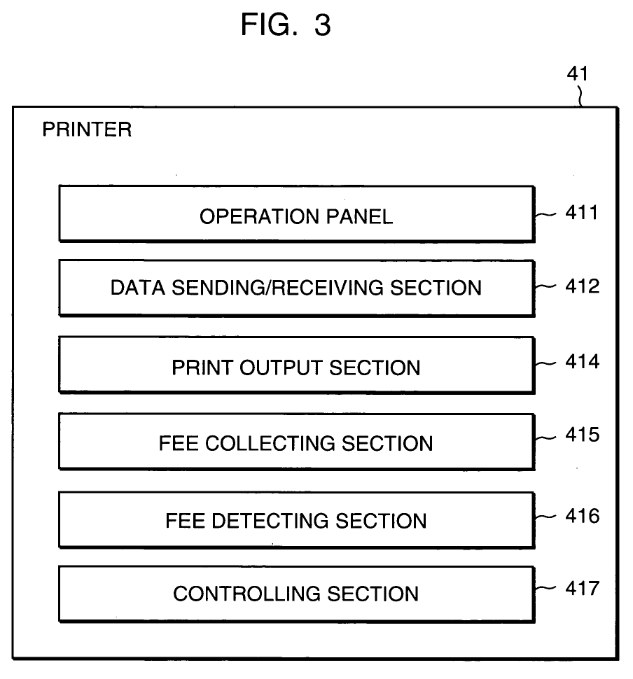

Next, an internal arrangement of the printer 41 (51, 61) is described. Since the internal arrangements of essential parts of the printers 41, 51, and 61 are identical to each other, the internal arrangement of the printer 41 is described as an exemplary arrangement in the following. FIG. 3 is a block diagram showing the internal arrangement of the printer 41. The printer 41 sends, to the document server 3, the document ID entered by the user, and receives, from the document server 3, the print data identified by the document ID to print the received print data.

The printer 41 is provided with an operation panel 411, a data sending/receiving section 412, a print output section 414, a fee collecting section 415, a fee detecting section 416, and a controlling section 417.

The operation panel 411 is used for the user to enter operation commands necessary for printout, as well as the document ID. The data sending/receiving section 412 communicates various data such as the document ID, the client data, the shop information, and the print data with the document server 3. The print output section 414 implements image formation based on the received print data, and outputs the received print data. The fee collecting section 415 is used for the user to put in a bank note or a coin as the print fee. The fee detecting section 416 detects whether the charged fee has been put in the fee collecting section 415. The controlling section 417 controls the data sending/receiving section 412 for data communication with the document server 3, controls the fee collecting section 415 for actuation, and controls the overall operations of the printer 41.

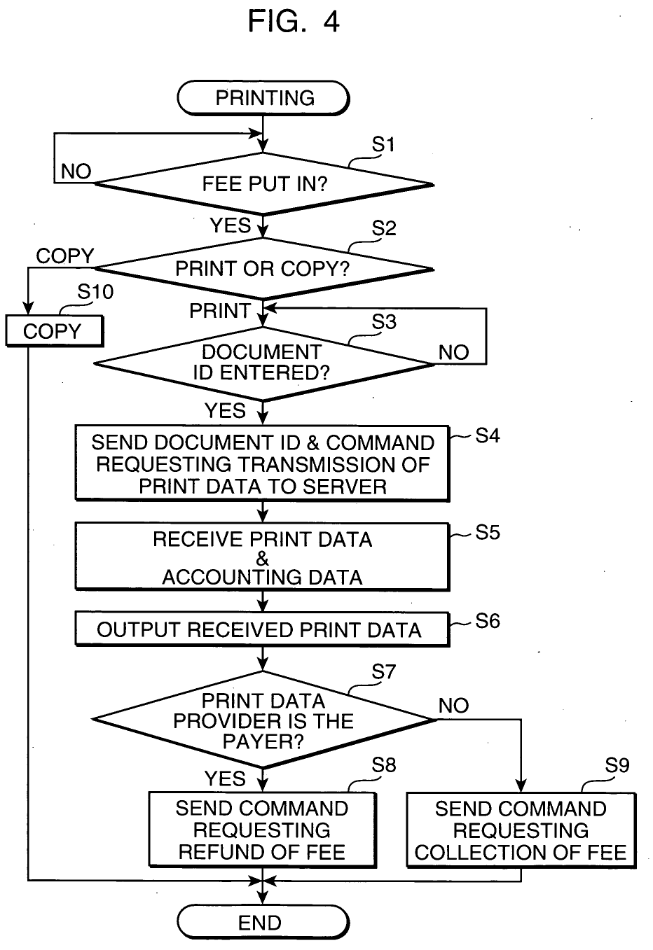

Now, a printing process by the printer 41 operated in the wide area network printing system 1 is described. FIG. 4 is a flowchart showing the printing process. When the fee detecting section 416 detects that the charged at least some fee has been put in (YES in Step S1), the controlling section 417 judges whether the printer is in a copy mode or a print mode based on a command entered through the operation panel 411 (Step S2). If it is judged that the printer is in the copy mode (COPY in Step S2), an ordinary copying process is implemented (Step S10).

If it is judged that the printer is in the print mode (PRINT in Step S2), the controlling section 417 controls the data sending/receiving section 412 to send, to the document server 3, the entered document ID and a command requesting transmission of print data (YES in Steps S3 and S4). When the data sending/receiving section 412 has received the print data requested by the command and identified by the document ID, and the accounting data including the payer information from the document server 3 (Step S5), the print output section 414 outputs the print data (Step S6). The “payer” in the present specification and the claims means a person who is to pay expenses relating to printout of print data by the printer 41, namely, the print fee, in the case where it is judged that the user (print data recipient) is the payer.

If the accounting data sent from the document server 3 indicates that the print data provider such as the administrator of the contents server 2 is the payer (YES in Step S7)., the controlling section 417 sends, to the fee collecting section 415, a command requesting refund of the fee which has been already put in the fee collecting section 415 (Step S8). On the other hand, if the accounting data sent from the document server 3 indicates that the user (print data recipient) is the payer (NO in Step S7), the controlling section 417 sends, to the fee collecting section 415, a command requesting collection of the print fee which has been already put in the fee collecting section 415 (Step S9). Alternatively, the print data may be outputted only after the print fee is collected by configuring the routine to implement the operations from Step 7 to Step 9 prior to the operation in Step S6.

Next, described is a process as to how the payer regarding print service is determined in the document server 3. Basically, the payer judging process regarding print service is implemented based on information attached to the document ID. For instance, in the case where the document ID consists of a number of digits, the payer judging section 310 judges that the print data provider is charged of the print fee relating to printout of the print data identified by the document ID, based on a detection that the first segment of the document ID is constituted of “0” or “00”.

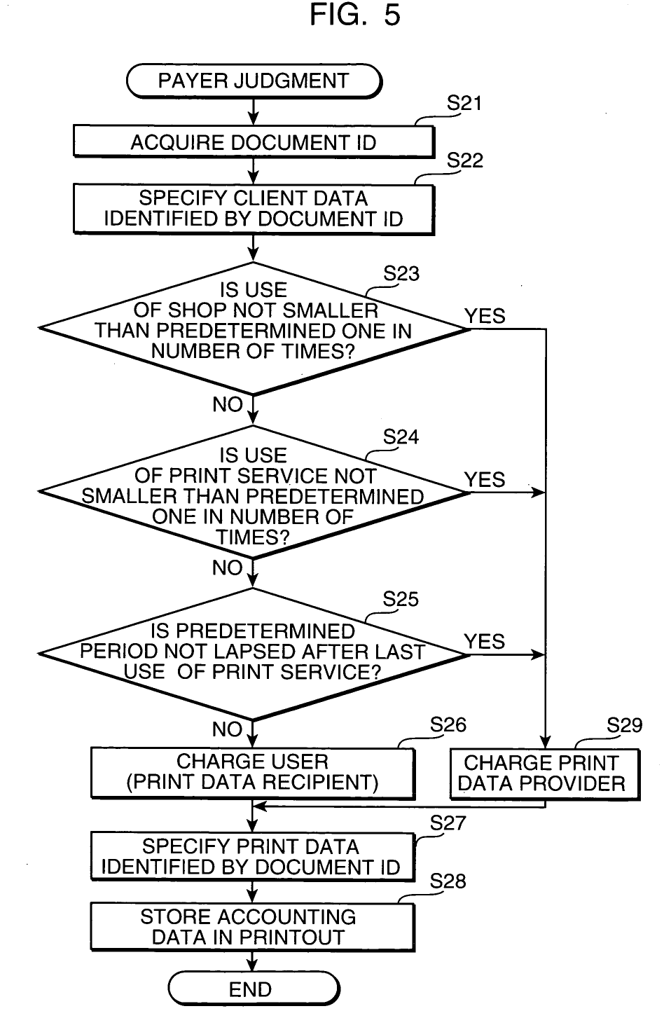

Charging depending on the user's status of use is possible if the system is so designed as to determine the payer depending on the conditions of the user's use of the shop or the like, which will be described in the following. FIG. 5 is a flowchart showing an exemplified process of determining the payer. For instance, when the communicating section 305 of the document server 3 acquires a document ID from the printer 41 (51 or 61) (Step S21), the controlling section 311 controls the data retrieving section 304 to retrieve the client data from the client data storing section 308 based on the user ID attached to the document. ID (Step S22).

Subsequently, the payer judging section 310 judges whether the number of times of the user's using the shop where the printer is installed, such as the convenience store 4, the print station 5, the hotel 6, or a like facility, is not smaller than a predetermined number of times, based on the contents of the retrieved client data (Step S23), judges whether the number of times of the user's using the print service in the shop is not smaller than a predetermined number of times (Step S24), and judges whether a predetermined period has not lapsed from the last time when the user used the print service (Step S25) If any one of the judgment results in Steps S23, S24, and S25 is affirmative (YES in Step S23 or S24 or S25), the payer judging section 310 judges that the print data provider is the payer who is to pay the fee relating to printout of the print data based on the document ID (Step S29).

If none of the judgment results in Steps S23, S24, and S25 is affirmative (NO in Steps S23, S24, and S25), the payer judging section 310 judges that the user (print data recipient) is the payer who is to pay the fee relating to printout of the print data based on the document ID (Step S26).

After Step S26, the data retrieving section 304 retrieves the print data identified by the document ID (Step S27). The accounting section 303 calculates the fee relating to printout of the print data, and stores the fee as print-fee-related accounting data, as well as the payer information (Step S28).

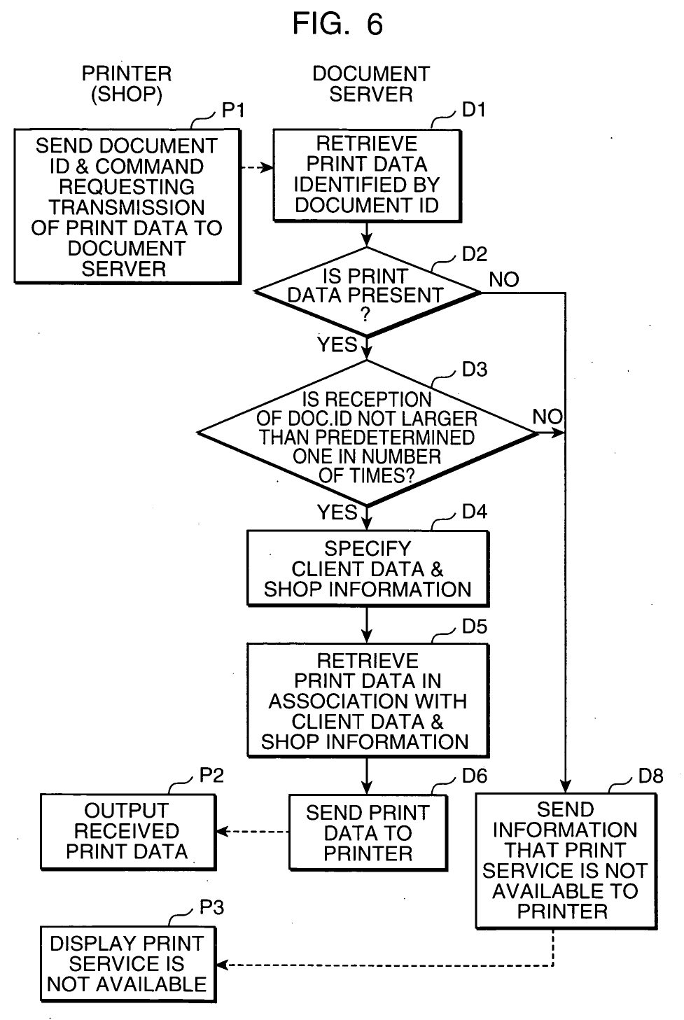

Next, described is a process of judging whether print data is to be sent to the printer based on the document ID, the client data, and the shop information implemented the document server 3. FIG. 6 is a flowchart showing processes by the printer 41 installed in the shop such as the convenience store 4, and the document server 3 in the case where the judging process is implemented by the document server 3. Steps to be implemented by the printer 41 are referred to as “steps P1, P2, . . . , and steps to be implemented by the document server 3 are referred to as “steps D1, D2, . . .”.

First, in response to input of the document ID on the operation panel 411 of the printer 41, data sending/receiving section 412 sends, to the document server 3, the document ID and a command requesting transmission of the print data (Step P1). When the communicating section 305 of the document server 3 receives the document ID and the command requesting transmission of the print data, the print data retrieving section 304 retrieves the print data identified by the document ID from the print data storing section 301 (Step D1).

If it is judged that the print data storing section 301 stores the print data identified by the document ID (YES in Step D2), the controlling section 311 judges whether the number of receiving the document ID is not larger than a predetermined number of times, e.g., three (Step D3). If the controlling section 311 judges that the number of receiving the document ID is not larger than the predetermined number of times (YES in Step D3), the controlling section 311 retrieves, the client data relating to the user specified by the received document ID from the client data storing section 308, retrieves the information relating to the shop which is specified based on the transmitted signal indicative of the document ID from the shop information storing section 309 (Step D4), and controls the data retrieving section 304 to retrieve the print data in association with the client data and the shop information from the print data storing section 301 (Step D5) . Thus, the controlling section 311 and the data retrieving section 304 constitute print data altering means of the present invention.

Subsequently, the communicating section 305 sends, to the printer 41, the print data identified by the document ID, as well as the print data which has been retrieved in association with the client data and the shop information (Step D6). When the data sending/receiving section 412 of the printer 41 receives these print data, the print output section 414 outputs the requested print data (Step P2).

On the other hand, if it is judged that the print data storing section 301 does not store the print data identified by the document ID (NO in Step D2), it is judged that the number of receiving the document ID exceeds the predetermined number of times (NO in Step D3), then, the controlling section 311 controls the communicating section 305 to send, to the printer 41, information that print service of the requested print data is not available (Step D8). When the data sending/receiving section 412 of the printer 41 receives the information, the controlling section 417 controls the display section of the operation panel 411 to display a message that print service of the requested print data is not available (Step P3).

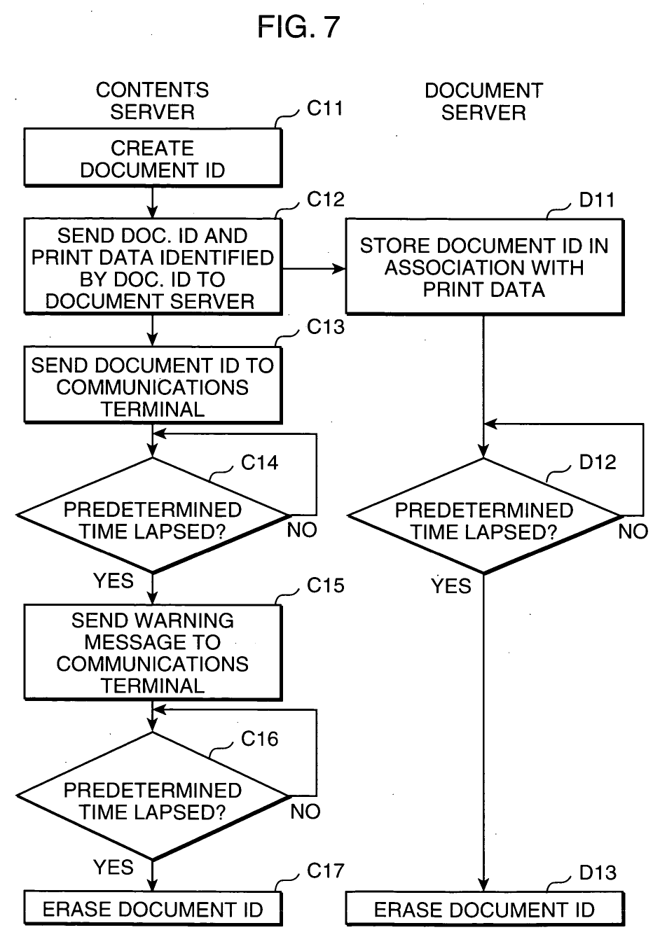

Next, administration of the document ID by the document server 3 is described. FIG. 7 is a flowchart showing processes by the contents server 2 and the document server 3 in administering the document ID. Steps to be implemented by the contents server 2 are referred to as “steps C11, C12, . . .”.

First the contents server 2 creates a document ID based on the user ID and the contents ID (Step C11). The contents server 2 sends, to the document server 3, the document ID, as well as the print data identified by the document ID (Step C12). In the case where plural document IDs for identifying single print data have been created and issued, and the print data has already been sent to the document server 3, the contents server 2 merely sends the document IDs. The contents server 2 also sends the document ID to the communications terminal such as the portable telephone 7 of each user (Step C13).

If a certain period, e.g., one week has lapsed from the time when the document ID has been created or alternatively from the time when the document ID has been sent to the user (YES in Step C14), the contents server 2 sends, to the communications terminal such as the portable telephone 7 of the user, a warning message indicating that the document ID will be erased shortly (Step C15). Specifically, the contents server 2 sends to the user a message indicating that print service of the print data based on the document ID will be invalid shortly. Upon lapse of a certain period, e.g., one day after sending the warning message (YES in Step C16), the contents server 2 erases the document ID in the contents server 2 (Step C17).

On the other hand, the controlling section 311 of the document server 3 controls the print data storing section 301 to store the document ID sent from the contents server 2 in association with the print data (Step D11). If the controlling section 311 judges that a predetermined period lapsed from the time when the document ID was sent (YES in Step D12), the controlling section 311 erases the document ID in the print data storing section 301 and in the document ID storing section 302 (Step D13). The timing of erasing the document ID in the document server 3 is substantially coincident with the timing of erasing the document ID in the contents server 2.

As described above, according to the wide area network printing system 1 of the embodiment of the present invention, the payer who is to pay the fee relating to printout of the print data provided from the contents server 2 is determined based on the document ID entered on the printer 41 by the user. If it is judged that the user (print data recipient) is the payer, the print fee is collected from the user with use of the printer 41 in the shop such as the convenience store 4. If it is judged that the print data provider such as the administrator of the contents server 2 is the payer, charging of the print fee to the user is prohibited. Thus, the system makes it possible to automatically judge whether the user is charged of the print fee. In this arrangement, if the distributor (print data provider) wishes to provide the users with the print data for free from the contents server 2 for advertisement and general publicity, the system is controlled so as not to charge the user for the print fee. On the other hand, the system makes it possible for an owner of the shop such as the convenience store 4 where the printer 41 is installed to securely collect, from the print data provider such as the administrator of the contents server 2, the cost required for printout of the print data, based on the accounting data stored in the accounting section 303 of the document server 3.

According to the wide area network printing system 1 of the embodiment of the present invention, the payer judging section (payer judging means)310 judges whether charging is necessary with respect to each client (user), based on the client data, such as the number of the user's visits to the shop where the printer (image forming apparatus) is installed, the accumulated used amounts by the user, and the accumulated number of times of utilizing the print service, in addition to the information readable from the document ID.

According to the wide area network printing system 1 of the embodiment of the present invention, the document server 3 alters the contents of the print data to be sent to the printer 41 depending on the client data. This arrangement makes it possible to provide the users with the print data whose contents are differentiated from each other, depending on the printing demand of each user. For instance, printing of coupons may be allowed to frequent users or heavy users of the printer in the shop in such a manner that discount percentages or discount amounts are differentiated among the users depending on the conditions of the users' using the shop such as the number of visits to the shop where the printer 41 is installed, the accumulated used amounts, and the accumulated number of times of utilizing the print service.

According to the wide area network printing system 1 of the embodiment of the present invention, the number of times of sending the print data identified by the document ID from the document server 3 to the printer 41 is restricted. This arrangement eliminates a drawback that unauthorized persons access the document server 3 to print out the print data identified by the document ID an unlimited number of times.

According to the wide area network printing system 1 of the embodiment of the present invention, since the document server 3 alters the contents of the print data to be sent to the printer 41 depending on the shop information, each user is provided with the print data whose contents are differentiated from each other depending on the features of the shop.

According to the wide area network printing system 1 of the embodiment of the present invention, since the document server 3 erases the document ID upon lapse of the predetermined period from the time when the document ID was created, the print service valid period of allowing printout of the print data based on the document ID can be restricted. In this arrangement, the user is motivated to visit the shop where the printer 41 is installed before the valid period expires. Thus, the system is effective in encouraging the users to visit the shop at least from the time when the document ID was loaded to the communications terminal of the user until the valid period expires.

According to the wide area network printing system 1 of the embodiment of the present invention, the user is alerted that output of the print data based on the document ID will be disabled shortly by way of the communications terminal of the user by allowing the contents server 2 to send, to the communications terminal of the user, a warning message that the document ID will be erased shortly. This arrangement is advantageous in urging the users to visit the shop where the printer is installed.

The present invention is not limited to the foregoing embodiment, and various modifications and alterations are applicable. For instance, in the above embodiment, the print data provider is determined as the payer if any one of the judgment results in Step S23, S24, and S25 is affirmative, e.g., a judgment result is that the number of times of the user's visiting the shop is not smaller than the predetermined number of times, in the payer judging process in FIG. 5. The requirement regarding the payer judging process is not limited thereto. Alternatively, the print data provider is determined as the payer, if all the judgment results in Step S23, S24, and S25 are affirmative.

In the above embodiment, the document server 3 is provided with the client data storing section 308 to judge whether charging is necessary based on the client data, and to alter the contents of the print data depending on the client data (see FIG. 6). Alternatively, the contents server 2 may be provided with a client data storing section. In the altered arrangement, for instance, the client data storing section of the contents server 2 may store client data, such as data relating to the frequency of use of the printer by the users, which is an important factor for the administrator of the contents server 2 such as the product distributor.

In the altered arrangement, the document server 3 may make a judgment regarding the payer based on the document ID, and alter the contents of the print data depending on the client data by acquiring the client data relating to the client identified by the document ID from the client data storing section of the contents server 2, or alternatively, the document server 3 may send the document ID to the contents server 2, which, in turn makes a judgment as to whether charging is necessary based on the document ID, alter the contents of the print data depending on the client data, and send, to the document server 3, the accounting data and the print data in association with the accounting data. In the latter case, the contents server 2 is so configured as to make a judgment regarding the payer, and alter the contents of the print data depending on the client data.

In the foregoing embodiment, the arrangements and the processes of the contents server 2, the document server 3, and the printer 41 (51 or 61) are illustrated from FIGS. 1 through 7. These arrangements and processes are merely examples of the present invention. The arrangement and the process of the inventive wide area network printing system 1 are not limited thereto.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A wide area network printing system which is so configured that, in response to receiving print data from a contents server providing various information including the print data, a document server sends the print data to an image forming apparatus which is installed remotely away from the document server but is communicatively connected therewith via the Internet for printout, wherein:
the image forming apparatus comprises:
an accepting unit that accepts input of a document ID used in verifying that receiving of print data is permitted;
a sending unit that sends the document ID inputted intro the accepting unit to the document server;
a receiving unit that receives print data from the document server; and
an outputting unit that outputs the print data, and
the document server comprises:
a storing unit that stores the print data sent from the contents server, and the document ID in association with the print data therein;
a print data retrieving unit that retrieves, from the storing unit, the print data identified by the document ID sent from the sending unit;
an accounting unit that calculates a fee relating to printout of the print data retrieved by the print data retrieving unit, and stores the fee as accounting data;
a payer judging unit that judges a payer of the fee relating to printout of the print data, based on the document ID;
a data sending unit that sends the print data and the accounting data to the receiving unit of the image forming apparatus; and
a controlling unit that controls the data sending unit to send, to the receiving unit of the image forming apparatus, the print data and the accounting data indicating that a print data recipient is the payer, if the payer judging unit judges that the print data recipient is the payer, and that controls the data sending unit to send, to the receiving unit of the image forming apparatus, the print data and the accounting data indicating that a print data provider is the payer, if the payer judging unit judges that the print data provider is the payer,
the image forming apparatus further comprising fee collecting unit that collects the fee from the print data recipient in the case where the receiving unit of the image forming apparatus receives, from the data sending unit of the document server, the accounting data indicating that the print data recipient is the payer.

2. The system according to claim 1, wherein at least one of the document server and the contents server further comprises a client data storing unit that stores data relating to clients therein, and the payer judging unit judges whether charging is necessary based on the client data.

3. The system according to claim 2, wherein at least one of the document server and the contents server further comprises print data altering unit that alters contents of the print data to be sent to the image forming apparatus depending on the client data.

4. The system according to claim 1, wherein the controlling unit of the document server restricts the number of transmissions of the print data identified by the document ID to the image forming apparatus when the document server receives the document ID from the image forming apparatus two or more number of times.

5. The system according to claim 3, wherein the document server further comprises a shop information storing unit that stores information relating to a shop where the image forming apparatus is installed, and the print data altering unit alters the contents of the print data to be sent to the image forming apparatus depending on the shop information.

6. The system according to claim 1, wherein the controlling unit of the document server erases the document ID upon lapse of a predetermined period from the time when the document server receives the document ID from the contents server.

7. The system according to claim 6, wherein the contents server sends, to a communications terminal, a warning message indicating that the document ID will be erased upon lapse of the predetermined period, before the predetermined period lapses.

8. A document server which is so configured as to receive print data from a contents server providing various information including the print data, and to send the print data to an image forming apparatus which is installed remotely away from the document server but is communicatively connected therewith via the Internet, the document server comprising:
a print data storing unit that stores print data sent from the contents server, and a document ID in association with the print data;
a print data retrieving unit that retrieves, from the print data storing unit, the print data in association with the document ID sent from the image forming apparatus;
a accounting unit that calculates a fee relating to printout of the print data retrieved by the print data retrieving unit, and stores the fee as accounting data;
a payer judging unit that judges a payer of the fee relating to printout of the print data, based on the document ID;
a data sending unit that sends the print data and the accounting data to the image forming apparatus; and
a controlling unit that controls the data sending unit to send, to the image forming apparatus, the print data and the accounting data indicating that a print data recipient is the payer, if the payer judging unit judges that the print data recipient is the payer, and that controls the data sending unit to send, to the image forming apparatus, the print data and the accounting data indicating that a print data provider is the payer, if the payer judging unit judges that the print data provider is the payer.

9. The document server according to claim 8, further comprising client data storing unit that stores data relating to clients therein, and the payer judging unit judges whether charging is necessary based on the client data.

10. The document server according to claim 9, further comprising a print data altering unit that alters contents of the print data to be sent to the image forming apparatus depending on the client data.

11. The document server according to claim 8, wherein the controlling unit restricts the number of transmissions of the print data identified by the document ID to the image forming apparatus when the document server receives the document ID from the image forming apparatus two or more number of times.

12. The document server according to claim 10, further comprising a shop information storing unit that stores information relating to a shop where the image forming apparatus is installed, wherein the print data altering unit alters the contents of the print data to be sent to the image forming apparatus depending on the shop information.

13. The document server according to claim 8, wherein the controlling unit erases the document ID upon lapse of a predetermined period from the time when the document server receives the document ID from the contents server.

14. An image forming apparatus which is so configured as to receive print data from a server via the Internet for printout of the print data, the apparatus comprising:
an inputting unit that allows a user to input a document ID used in verifying that receiving of print data is permitted;
a sending unit that sends the document ID inputted to the inputting unit to the server;
a receiving unit that receives print data identified by the document ID sent from the sending unit, and accounting data including information relating to a payer which is determined based on the document ID;
an outputting unit that outputs the print data received by the receiving unit; and
a fee collecting unit that collects a certain fee from a print data recipient if the print data recipient is determined as the payer based on the accounting data received by the receiving unit.
